(19) United States
(12) Patent Application Publication
(10) Pub. No.: US 2025/0294461 A1
(43) Pub. Date: Sep. 18, 2025

(54) WAKEUP SIGNAL PATTERN SELECTION FOR RECEIVER DEVICES

(71) Applicant: Nokia Technologies Oy, Espoo (FI)

(72) Inventors: Oana-Elena BARBU, Aalborg (DK); Benny VEJLGAARD, Aalborg (DK)

(21) Appl. No.: 18/865,645

(22) PCT Filed: May 9, 2023
(86) PCT No.: PCT/IB2023/054810

§ 371 Date: Nov. 13, 2024

Related U.S. Application Data
(60) Provisional application No. 63/346,258, filed on May 26, 2022.

(51) Int. Cl. H04W 52/02; H04W 8/22

(52) U.S. Cl. CPC H04W 52/0235; H04W 8/22; H04W 52/028

(57) ABSTRACT

Systems, methods, apparatuses, and computer program products for wakeup signal pattern selection for receiver devices. A method may include transmitting an indication of one or more wakeup receiver capabilities to a network element. The method may also include receiving an activated wakeup signal pattern from the network element selected from one or more wakeup signal patterns. In addition, the method may include activating the one or more wakeup receiver capabilities at the wakeup receiver based on the activated wakeup signal pattern.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for wakeup signal pattern selection for receiver devices.

### BACKGROUND

Examples of mobile or wireless telecommunication systems may include the Universal Mobile Telecommunications System (UMTS), Long Term Evolution (LTE), LTE-Advanced (LTE-A), LTE-A Pro, and/or fifth generation (5G) or New Radio (NR) telecommunications systems, and future generation of telecommunications systems. Fifth generation (5G) telecommunications systems refer to the next generation (NG) of radio access networks and network architectures for core networks. A 5G telecommunication system is mostly based on new radio (NR) radio access technology (5G NR), but a 5G (or NG) network can also build on E-UTRAN. It is estimated that 5G NR will provide bitrates on the order of 10-20 Gbit/s or higher, and will support at least enhanced mobile broadband (eMBB) and ultra-reliable low-latency communication (URLLC) as well as massive machine-type communication (mMTC). 5G NR is expected to deliver extreme broadband and ultra-robust, low-latency connectivity and massive networking to support the Internet of Things (IoT).

### SUMMARY

Some example embodiments may be directed to a method. The method may include transmitting an indication of one or more wakeup receiver capabilities to a network element. The method may also include receiving an activated wakeup signal pattern from the network element selected from one or more wakeup signal patterns. In addition, the method may include activating the one or more wakeup receiver capabilities at the wakeup receiver based on the activated wakeup signal pattern.

Other example embodiments may be directed to an apparatus. The apparatus may include at least one processor and at least one memory including computer program code. The at least one memory and computer program code may also be configured to, with the at least one processor, cause the apparatus at least to transmit an indication of one or more wakeup receiver capabilities to a network element. The apparatus may also be caused to receive an activated wakeup signal pattern from the network element selected from one or more wakeup signal patterns. In addition, the apparatus may be caused to activate the one or more wakeup receiver capabilities at the wakeup receiver based on the activated wakeup signal pattern.

Other example embodiments may be directed to an apparatus. The apparatus may include means for transmitting an indication of one or more wakeup receiver capabilities to a network element. The apparatus may also include means for receiving an activated wakeup signal pattern from the network element selected from one or more wakeup signal patterns. In addition, the apparatus may include means for activating the one or more wakeup receiver capabilities at the wakeup receiver based on the activated wakeup signal pattern.

In accordance with other example embodiments, a non-transitory computer readable medium may be encoded with instructions that may, when executed in hardware, perform a method. The method may include transmitting an indication of one or more wakeup receiver capabilities to a network element. The method may also include receiving an activated wakeup signal pattern from the network element selected from one or more wakeup signal patterns. In addition, the method may include activating the one or more wakeup receiver capabilities at the wakeup receiver based on the activated wakeup signal pattern.

Other example embodiments may be directed to a computer program product that performs a method. The method may include transmitting an indication of one or more wakeup receiver capabilities to a network element. The method may also include receiving an activated wakeup signal pattern from the network element selected from one or more wakeup signal patterns. In addition, the method may include activating the one or more wakeup receiver capabilities at the wakeup receiver based on the activated wakeup signal pattern.

Other example embodiments may be directed to an apparatus that may include circuitry configured to transmit an indication of one or more wakeup receiver capabilities to a network element. The apparatus may also include circuitry configured to receive an activated wakeup signal pattern from the network element selected from one or more wakeup signal patterns. In addition, the apparatus may include circuitry configured to activate the one or more wakeup receiver capabilities at the wakeup receiver based on the activated wakeup signal pattern.

Certain example embodiments may be directed to a method. The method may include receiving an indication of one or more wakeup receiver capabilities from a user equipment. The method may also include monitoring one or more conditions of the user equipment. In addition, the method may include activating a wakeup signal pattern based on the monitoring of the one or more conditions of the user equipment. Further, the method may include transmitting the activated wakeup signal pattern to the user equipment.

Other example embodiments may be directed to an apparatus. The apparatus may include at least one processor and at least one memory including computer program code. The at least one memory and computer program code may be configured to, with the at least one processor, cause the apparatus at least to receive an indication of one or more wakeup receiver capabilities from a user equipment. The apparatus may also be caused to monitor one or more conditions of the user equipment. In addition, the apparatus may be caused to activate a wakeup signal pattern based on the monitoring of the one or more conditions of the user equipment. Further, the apparatus may be caused to transmit the activated wakeup signal pattern to the user equipment.

Other example embodiments may be directed to an apparatus. The apparatus may include means for receiving an indication of one or more wakeup receiver capabilities from a user equipment. The apparatus may also include means for monitoring one or more conditions of the user equipment. In addition, the apparatus may include means for activating a wakeup signal pattern based on the monitoring of the one or more conditions of the user equipment. Further, the apparatus may include means for transmitting the activated wakeup signal pattern to the user equipment.

In accordance with other example embodiments, a non-transitory computer readable medium may be encoded with instructions that may, when executed in hardware, perform a method. The method may include receiving an indication of one or more wakeup receiver capabilities from a user equipment. The method may also include monitoring one or more conditions of the user equipment. In addition, the method may include activating a wakeup signal pattern based on the monitoring of the one or more conditions of the user equipment. Further, the method may include transmitting the activated wakeup signal pattern to the user equipment.

Other example embodiments may be directed to a computer program product that performs a method. The method may include receiving an indication of one or more wakeup receiver capabilities from a user equipment. The method may also include monitoring one or more conditions of the user equipment. In addition, the method may include activating a wakeup signal pattern based on the monitoring of the one or more conditions of the user equipment. Further, the method may include transmitting the activated wakeup signal pattern to the user equipment.

Other example embodiments may be directed to an apparatus that may include circuitry configured to receive an indication of one or more wakeup receiver capabilities from a user equipment. The apparatus may also include circuitry configured to monitor one or more conditions of the user equipment. In addition, the apparatus may include circuitry configured to activate a wakeup signal pattern based on the monitoring of the one or more conditions of the user equipment. Further, the apparatus may include circuitry configured to transmit the activated wakeup signal pattern to the user equipment.

### BRIEF DESCRIPTION OF THE DRAWINGS

For proper understanding of example embodiments, reference should be made to the accompanying drawings, wherein:

FIG. 1 illustrates an example concept for waking up a New Radio receiver.

FIG. 2 illustrates example wakeup signal patterns, according to certain example embodiments.

FIG. 3 illustrates an example signaling diagram, according to certain example embodiments.

FIG. 4 illustrates an example flow diagram of a method, according to certain example embodiments.

FIG. 5 illustrates an example flow diagram of another method, according to certain example embodiments.

FIG. 6 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for wakeup signal pattern selection for receiver devices. In some example embodiments, the receiver devices may include hybrid wakeup receiver devices.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

In 3^{rd} Generation Partnership Project (3GPP) and 5G NR, 5G systems have been designed and developed to target both mobile telephony and vertical use cases. Aside from latency, reliability, and availability, user equipment (UE) energy efficiency can be important to 5G. Currently, 5G devices may need to be recharged on a per week or day basis, depending on usage time. In general, 5G devices consume tens of milliwatts in radio resource control (RRC) idle/inactive state, and hundreds of milliwatts in RRC connected state. As such, designs to prolong battery life may be needed to improve energy efficiency as well as user experience.

Energy efficiency can be important for UEs without a continuous energy source (e.g., UEs using small rechargeable and single coin cell batteries). Among vertical use cases, sensors and actuators may be deployed extensively for monitoring, measuring, charging, etc. Generally, their batteries may not be rechargeable and expected to last at least few years. For example, these batteries may be associated with wearable devices including, for example, smart watches, rings, eHealth related devices, and medical monitoring devices.

In some cases, power consumption may depend on the configured length of wakeup periods (e.g., paging cycle). To meet the battery life requirements noted above, extended discontinuous reception (eDRX) cycle with a large value can be used, resulting in high latency, which is not suitable for such services with requirements of both long battery life and low latency. For example, in a fire detection and extinguishment use case, fire shutters may be closed, and fire sprinklers may be turned on by the actuators within 1 to 2 seconds from the time the fire is detected by sensors. In such a case, a long eDRX cycle would not be able to meet the delay requirements, and eDRX may not be suitable for latency-critical use cases.

Currently, UEs may need to periodically wakeup once per DRX cycle, which dominates the power consumption in periods with no signaling or data traffic. If UEs are able to wakeup only when they are triggered (e.g., paging), power consumption could be dramatically reduced. This can be achieved by using a wakeup signal to trigger the main radio and a separate receiver which has the ability to monitor wakeup signal with ultra-low power consumption. The main radio may work for data transmission and reception, which can be turned off or set to deep sleep unless it is turned on. Additionally, the power consumption for monitoring wakeup signal may depend on the wakeup signal design and the hardware module of the wakeup receiver used for signal detecting and processing.

Internet of Things (IoT) applications may also need to satisfy certain power requirements. For instance, 3GPP has specified narrowband Internet of Things (NB-IoT)/enhanced machine-type communication (eMTC), and NR RedCap to satisfy the requirements on low cost and low power devices for wide area IoT communication. These IoT devices may consume tens or hundreds of milliwatts power during transceiving, while the cost is a few dollars. However, to achieve the internet of everything, IoT devices with ten or even a hundred times lower cost and power consumption may be needed, especially for a large number of applications requiring battery-less devices.

Furthermore, the number of IoT connections has been growing rapidly. With more and more things expected to be interconnected for improving production efficiency and increasing comforts of life, it demands further reduction of size, cost, and power consumption for IoT devices. In particular, regular replacement of battery for all the IoT devices is impractical due to the tremendous consumption of materials and manpower. It has become a trend to use energy harvested from environments to power IoT devices for self-sustainable communications, especially in applications with a large number of devices (e.g., ID tags and sensors).

3GPP has also specified potential issues for target use cases in the capability of cooperating with energy harvesting in view of limited device sizes. For instance, cellular devices usually consume tens or even hundreds of milliwatts power for transceiving processing. Taking NB-IoT module for example, the typical current absorption for receive processing is about 60 mA with supply voltage higher than 3.1V, while 70 mA for transmitting processing at 0 dBm transmit power. The output power provided by typical energy harvester is mostly below 1 milliwatt, considering the small size of a few square centimeters for practical devices. Since the available power is far less than the consumed power, it is impractical to power cellular devices directly by energy harvesting in most cases.

One possible solution to the power consumption issue may be to integrate energy harvesting with rechargeable battery or supercapacitor. However, both rechargeable battery and supercapacitor may suffer from shortened lifetime in practical cases. It may be difficult to provide constant charging current or voltage by energy harvesting, while longtime continuous charging is needed due to the very small output power from energy harvester. Inconstant charging current and longtime continuous charging can both be harmful to battery life.

For a supercapacitor, its lifetime may be significantly reduced in high temperature environments (e.g., less than 3 years at 50 degrees centigrade). Additionally, device size may be significantly increased. As a small size button battery can only provide current of a few tens of milliamps, a battery with a much larger size (e.g., AA battery) may usually be used to power cellular devices, whose size can be even larger than the module itself. To store energy for a proper duration of working (e.g., one second), the required capacitance of a supercapacitor may be at the level of a hundred mill-farads. The size of such supercapacitors may be larger than an NB-IoT module. Further, both rechargeable batteries and supercapacitors can be more expensive than the module itself.

For non-3GPP technologies such as radio-frequency identification (RFID) technology may support batteryless tags (devices). The power consumption of commercial passive RFID tags can be as low as 1 microwatt. The techniques enabling such low power consumption include envelope detection for downlink data reception, and backscatter communication for uplink data transmission. RFID is designed for short-range communications, whose typical effective range is less than 10 meters. As the air interface of RFID almost remains unchanged, the simple transmission scheme can become an obstacle to improving its link budget and capability of supporting scalable network.

For NR power saving, a dedicated signal may be defined to instruct the UE to wakeup at the next DRX on-duration. This signal may be defined as downlink control information (DCI) with cyclic redundancy check (CRC) scrambled by paging system radio network temporary identifier (PS-RNTI), which may also be known as “DCP”. If a UE does not receive the DCP during the network-defined wakeup occasion(s), or a received DCP does not contain a wakeup indication, the UE may assume there is no data, and can skip monitoring the physical downlink control channel (PDCCH) during the next DRX-on duration. Thus, saving power may be achieved when no data is present. Further, to minimize false alarms (leading to waking up a UE unnecessarily), the DCP wakeup signal (WUS) may be targeted to a UE specific identifier such as, for example, the PS-RNTI.

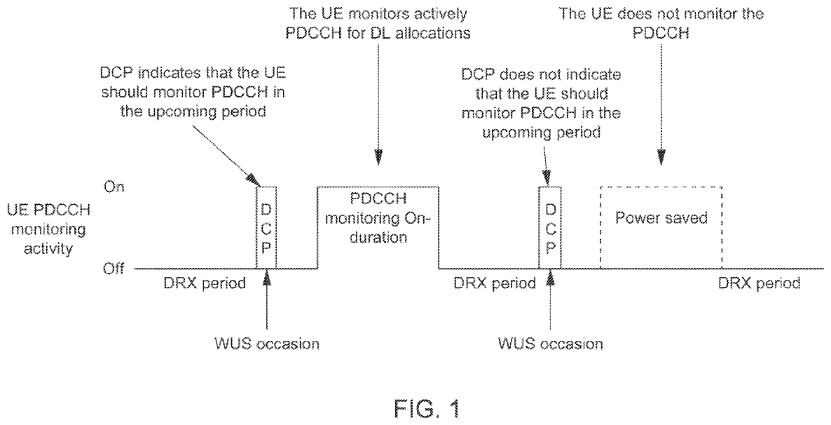

FIG. 1 illustrates an example DCP concept for waking up a NR receiver. To monitor a WUS occasion, the UE may use a simple wakeup receiver (WRx). In some cases, even when the WRx has reduced capability, it may still be an active unit (i.e., it may consume power to run (unlike a passive unit that does not have a power source)). Upon detection of the UE-specific WUS signal by the WRx, the latter may trigger the full NR baseband (BB) receiver (BBRx) to wakeup to monitor the next PDCCH occasion. Further, since the WRx may need to be active for all WUS occasions, the power saving that can be achieved with the WUS framework may be upper bounded by the costs of running the WRx. On the other hand, for a power limited UE, there may be a concern for how the costs of running the WRx can be minimized.

In view of the challenges exhibited by the conventional WUS framework, certain example embodiments may provide a way to minimize the costs associated with monitoring WUS occasions, and improve the power saving of an NR UE. For instance, certain example embodiments may leverage an augmented WRx architecture where the WRx can be implemented as a hybrid structure containing a passive branch and an active branch, the latter of which may implement the standard NR wakeup detector.

Additionally, in certain example embodiments, the network may dynamically change the WUS pattern using information about the UE's intrinsic condition (e.g., battery level) and/or an extrinsic condition (e.g., coarse location such as, for example, a serving beam index, proximity to other UEs, etc.). In some example embodiments, the WUS pattern may be defined in relation to a WUS passive occasion (PO) associated with a first type of WUS signal. In other example embodiments, the WUS pattern may be defined in relation to a WUS active occasion (AO) associated with a second type of WUS signal. In further example embodiments, the WUS pattern may be defined in relation to a WUS hybrid occasion (HO) that combines PO and AO associated with a third type of WUS signal, where the first, second, and third signal types may or may not be generated the same/similarly. In some example embodiments, during the PO WUS, the WRx may use the passive radio to detect the signal, while during the AO WUS, the WRx may enable, switch on, or otherwise use the active branch.

According to certain example embodiments, the UE may inform the NW (e.g., serving gNB) about the WRx capabilities for passive or active detection. In some example embodiments, a passive detection level (e.g., signal decoding or signal demodulation) may also be indicated. In response to the information received from the UE concerning the WRx capabilities, the serving gNB may monitor at least the extrinsic condition of the UE including, for example, the UE coarse location information, and/or the UE proximity such as the number of nearby UEs. In other example embodiments, the serving gNB may also monitor the intrinsic condition of the UE including, for example, a battery level of the UE.

In certain example embodiments, when there is a change in the extrinsic or intrinsic conditions of the UE, and/or when the WUS source changes (e.g., a sidelink (SL) UE is empowered to send WUS on behalf of the network (NW)), the gNB may update the WUS pattern. In other example embodiments, the network may also use the capability indication from the information obtained from the UE to determine the pattern and signal types of the WUS. According to some example embodiments, the WUS pattern may be defined by a validity duration D (i.e., a time interval where the pattern applies), or a combination of PO, AO, and HO.

According to certain example embodiments, the UE itself may also trigger a re-evaluation of the WUS pattern via an explicit WUS pattern change request. For instance, in certain example embodiments, the UE may request the gNB to evaluate whether a pattern change is beneficial. The UE may also request this after it has observed one or more WUS detection errors associated with the current pattern. According to other example embodiments, the serving gNB may send the new updated WUS pattern to the UE via a RRC or medium access control (MAC) control element (MAC CE). Alternatively, in other example embodiments, the serving gNB may send an index to a pattern e.g., if a list of patterns or some other reference to a set of patterns was already communicated to the UE in response to the UE informing the NW about the WRx capabilities.

In certain example embodiments, once the updated WUS pattern has been received from the serving gNB, the UE may apply the updated WUS pattern to the WRx. For instance, if the WUS pattern is a WUS PO, the WRx may use, enable, or switch on the passive radio, which may harvest energy from the WUS signal and generate a binary signal (i.e., 1—if the passive radio recognizes an ID of the UE in the WUS). However, if the WUS pattern is a WUS AO, the WRx may use, enable, or switch on the active branch and the standard active detection may be performed. Further, if the WUS pattern is a WUS HO, the WRX may use, enable, or switch on the passive branch while also buffering the signal samples in the WRx memory. According to certain example embodiments, if the energy harvested is insufficient to power the passive radio, the active WRx may be triggered, and the buffered signal may be sent for decoding to the active branch.

As noted above, certain example embodiments may provide a NR WUS dynamic pattern selection and deployment that may reduce the power consumption of the WRx used to wakeup the BBRx of an NR UE. In certain example embodiments, the NR WRx may have two branches including, for example, a passive branch and an active branch. With regard to the passive branch, this branch may be implemented by means of a passive radio. For instance, the passive radio may be a radio that harvests energy from the incoming signal and generates a backscatter signal by modulating the incoming signal according to a predefined pattern representative of what the radio received, if the incoming signal was intended for the passive radio. Further, the backscatter signal may be a binary signal where the passive radio generates a “1” if the signal was intended for the UE. Thus, the backscatter signal may act as a trigger for BBRx. As to the active branch, this may be implemented by means of an active radio. According to some example embodiments, the active radio may be a NR detector that orthogonal frequency division multiplexing (OFDM) which demodulates the signal, and then decodes it.

In certain example embodiments, the WUS dynamic pattern selection may use the double-branch WRx architecture above, and may be updated by the NW upon detecting a change in the environment of the UE. According to certain example embodiments, a change may occur when/if the WUS source changes. For instance, the NW may designate a close-by UE or roadside unit (RSU) to send a WUS signal to the UE. In other example embodiments, the change may occur when/if the UE battery status changes. For instance, the UE may express a preference for using the passive branch more often/exclusively due to severely limiting battery power. In further example embodiments, the change may occur when/if the NW/UE has recorded a large number of false positive or false negative wakeup decisions (i.e., detection errors) by the WRx.

In other words, according to certain example embodiments, the WRx may have failed to correctly interpret the WUS signal either due to bad channel conditions, and/or a poor WUS pattern. As described above, according to certain example embodiments, when there is a large number of detection errors (e.g., exceeding or otherwise satisfying a threshold number of detection errors), the UE may also explicitly request a WUS pattern change, which may then trigger a similar assessment at the NW side. In some example embodiments, the threshold for the number of detection errors may be a UE implementation, or selected by the NW. For instance, if the error rate is more than a predefined percentage (e.g., 60%), then the NW or UE may request for a change in the WUS pattern.

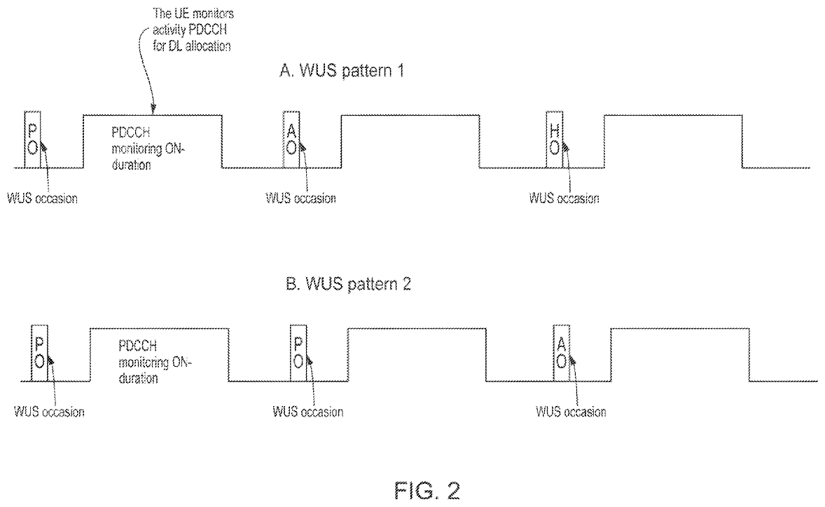

FIG. 2 illustrates example WUS patterns, according to certain example embodiments. As illustrated in FIG. 2, once the NW has detected a change and/or a cause of the change in a condition associated with a UE, the NW may generate an updated WUS pattern. As described above, and as illustrated in FIG. 2, there may be one or more WUS occasions that may be used to define a WUS pattern. For instance, there may be a PO WUS, which may be associated with sending a WUS signal targeted at the passive WRx. Such PO WUS signal may be selected in relation to the passive WRx capability, specifically if the passive branch can decode. In this case, the PO WUS may be an OFDM signal where each subcarrier contains complex modulated and encoded data. In other example embodiments, the passive branch may demodulate the WUS signal. In this case, the PO WUS may be a raw reference signal such as, for example, a Zadoff-Chu or Gold sequence. In certain example embodiments, such passive WRx capability indication(s) may be transferred to the NW once, for example, when the UE registers to the NW.

Another WUS pattern may include an AO WUS, which may be associated with sending a WUS signal targeted at the active WRx branch. In this situation, the AO WUS may implement the standard NR DCP signal, and the active branch may implement the detection of PS-RNTI.

In other example embodiments, the WUS pattern may also include a HO WUS associated with sending a WUS signal targeted first at the passive WRx branch, and only upon detection failure by the passive radio, targeted at the active WRx branch. In this case, the HO WUS may include a first set of resources used for a PO WUS, and a second set of resources used for transmitted an AO WUS. In this context, a resource may refer to a set of resource elements (REs), physical resource blocks (PRBs), a carrier, a BWP, etc. For example, according to certain example embodiments, a HO WUS may be generated by assigning N REs for transmitting a PO WUS, and assigning the remaining REs for an AO WUS, where N may represent a number of indices of RE in a given BW.

According to certain example embodiments, once the HO WUS has been generated, the WRx may trigger a memory buffer to store RE N+1:M. Additionally, the WRx may trigger the passive branch to detect RE 1:N. If the detection fails (e.g., the passive branch does not generate an intelligible backscatter signal (e.g., 1 or 0)), then the active branch may be activated and the buffered samples may be used as input for the subsequent detection.

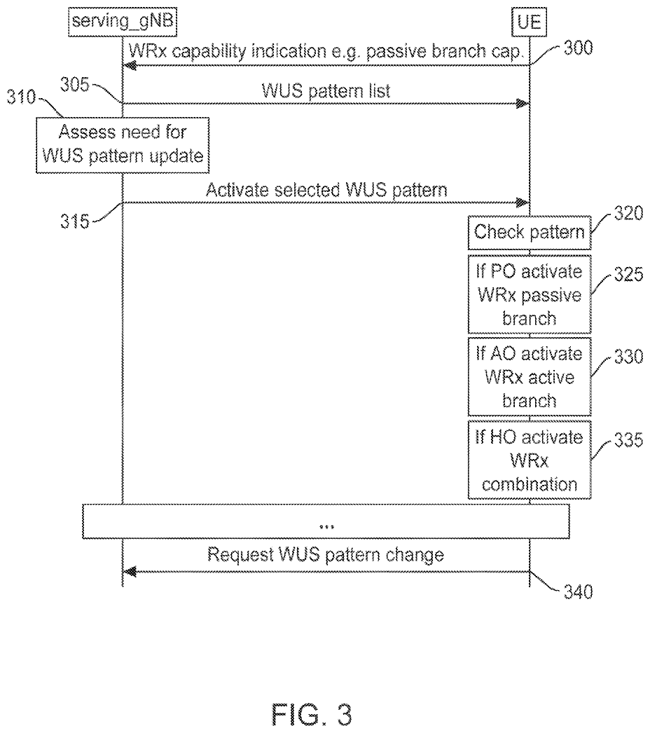

FIG. 3 illustrates an example signaling diagram, according to certain example embodiments. At 300, the UE may inform the serving gNB about the WRx capabilities for passive or active detection. At 305, in response to receiving the information on the WRx capabilities, the serving gNB may send a WUS pattern list or some other reference to a set of one or more WUS patterns to the UE. For instance, in certain example embodiments, if the UE indicates that the WRx capability is for passive branch, then only PO signals may be sent. On the other hand, if the UE indicates that the WRx capability is for active branch, then only AO signals may be sent. Further, if the UE indicates that the WRx capability is a hybrid of the passive branch and active branch, then, a combined pattern may be sent. Additionally, if the UE has, additionally reported low power, then the combined pattern may have multiple PO occurrences, and a few AO and/or HO occurrences. At 310, the serving gNB may assess a need for updating a current WUS pattern. That is, the gNB may assess whether it needs to activate another pattern from a list sent at operation 305. In some example embodiments, the assessment may be based on one or more of a number of detection errors, and changes of the extrinsic and/or intrinsic conditions of the UE. Once the serving gNB completes the assessment, the serving gNB may, at 315, the serving gNB may activate a selected pattern which was determined based on the assessment. Once the selected WUS pattern has been activated, at 320, the UE may check the selected WUS pattern to determine whether the WUS pattern is a PO WUS, AO WUS, or HO WUS.

At 325, if the WUS pattern is a PO WUS, the UE may active the WRx passive branch. At 330, if the WUS pattern is a AO WUS, the UE may activate the WRx active branch. However, at 335, if the WUS pattern is a HO WUS, the UE may activate the WRx combination of the passive branch and the active branch. After the appropriate branch of the WRx has been activated, at 340, the UE may send a request to the serving gNB to change the WUS pattern. As an illustrative example, the gNB may assess whether it needs to activate another pattern from a list sent to the UE at operation 305. The list may include, for example, various patterns such as, pattern 1, 2, 3, etc. The gNB may then activate the first pattern 1, and the UE may receive pattern 1 for a time-window and monitor the detection error for that pattern. If it is determined that the error is high, the UE may submit a request for a pattern change to the gNB. Upon receipt of the request, the gNB may assess the request and change the pattern to, for example, pattern 2. In certain example embodiments, this process may be repeated one or more times.

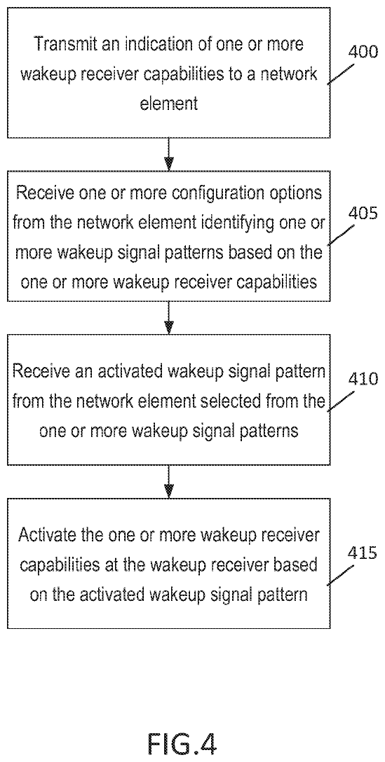

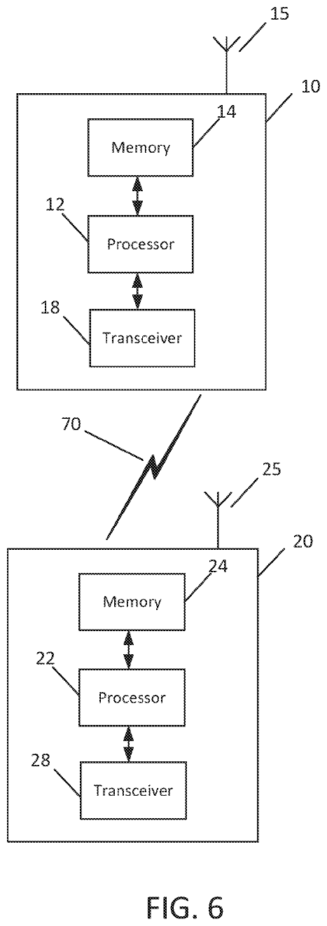

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a UE or device similar to one of apparatuses 10 or 20 illustrated in FIG. 6.

According to certain example embodiments, the method of FIG. 4 may include, at 400, transmitting an indication to of one or more wakeup receiver capabilities to a network element. The method may also include, at 405, receiving one or more configuration options from the network element identifying one or more wakeup signal patterns based on the one or more wakeup receiver capabilities. The method may further include, at 410, receiving an activated wakeup signal pattern from the network element selected from the one or more wakeup signal patterns. In addition, the method may include, at 415, activating the one or more wakeup receiver capabilities at the wakeup receiver based on the activated wakeup signal pattern.

According to certain example embodiments, the one or more wakeup receiver capabilities may include a passive branch capability or an active branch capability. According to some example embodiments, the one or more wakeup receiver capabilities may include an active branch capability, and a passive branch capability. According to other example embodiments, the activated wakeup signal pattern may include a passive occasion wakeup signal, an active occasion wakeup signal, or a hybrid occasion wakeup signal.

In certain example embodiments, when the activated wakeup signal pattern comprises the passive occasion wakeup signal, activating the one or more wakeup receiver capabilities may include switching on or using a passive radio of a wakeup receiver. In some example embodiments, the passive radio may harvest energy from the passive occasion wakeup signal and generates a binary signal. In other example embodiments, when the activated wakeup signal pattern includes the active occasion wakeup signal, activating the one or more wakeup receiver capabilities may include switching on or using an active branch of a wakeup receiver. In further example embodiments, when the activated wakeup signal pattern includes the hybrid occasion wakeup signal, activating the one or more wakeup receiver capabilities may include switching on or using a passive branch of a wakeup receiver while also buffering the hybrid occasion wakeup signal in stored in a non-transitory computer readable medium.

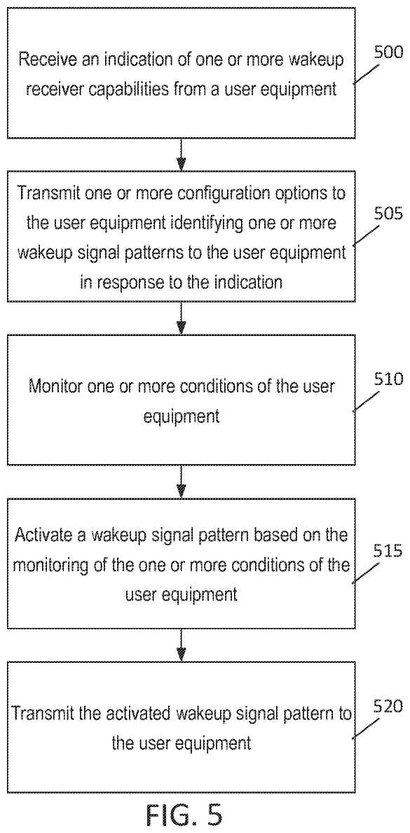

FIG. 5 illustrates an example of a flow diagram of another method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a network or gNB similar to one of apparatuses 10 or 20 illustrated in FIG. 6.

According to certain example embodiments, the method of FIG. 5 may include, at 500, receiving an indication of one or more wakeup receiver capabilities from a user equipment. The method may also include, at 505, transmitting one or more configuration options to the user equipment identifying one or more wakeup signal patterns to the user equipment in response to the indication. The method may further include, at 510, monitoring one or more conditions of the user equipment. In addition, the method may include, at 515, activating a wakeup signal pattern based on the monitoring of the one or more conditions of the user equipment. Further, the method may include, at 520, transmitting the activated wakeup signal pattern to the user equipment.

According to certain example embodiments, the activated wakeup signal may be transmitted to the user equipment via a radio access control or a medium access control control element. According to some example embodiments, the one or more conditions may include extrinsic and intrinsic conditions of the user equipment. In certain example embodiments, the extrinsic conditions may include a coarse location or a network load in the user equipment proximity, and the intrinsic conditions may include a user equipment battery level. According to other example embodiments, the monitoring may further include recording a number of false positive or false negative wakeup decisions by the user equipment.

In certain example embodiments, the one or more wakeup receiver capabilities may include a passive branch capability or an active branch capability. In some example embodiments, the one or more wakeup receiver capabilities may include an active branch capability, and a passive branch capability. In other example embodiments, the activated wakeup signal pattern may include a passive occasion wakeup signal, an active occasion wakeup signal, or a hybrid occasion wakeup signal. In further example embodiments, the activated wakeup signal pattern may be defined by a validity duration, or a combination of the passive occasion wakeup signal, the active occasion wakeup signal, and the hybrid occasion wakeup signal.

FIG. 6 illustrates a set of apparatus 10 and 20 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 6.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 6.

As illustrated in the example of FIG. 6, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-4.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-4.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to transmit an indication of one or more wakeup receiver capabilities to a network element. Apparatus 10 may also be controlled by memory 14 and processor 12 to receive an activated wakeup signal pattern from the network element selected from one or more wakeup signal patterns. In addition, apparatus 10 may be controlled by memory 14 and processor 12 to activate the one or more wakeup receiver capabilities at the wakeup receiver based on the activated wakeup signal pattern.

As illustrated in the example of FIG. 6, apparatus 20 may be a network, core network element, or element in a communications network or associated with such a network, such as gNB. It should be noted that one of ordinary skill in the art would understand that apparatus 20 may include components or features not shown in FIG. 6.

As illustrated in the example of FIG. 6, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-3 and 5.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-3 and 5.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to receive an indication of one or more wakeup receiver capabilities from a user equipment. Apparatus 20 may also be controlled by memory 24 and processor 22 to monitor one or more conditions of the user equipment. In addition, apparatus 20 may be controlled by memory 24 and processor 22 to activate a wakeup signal pattern based on the monitoring of the one or more conditions of the user equipment. Further, apparatus 20 may be controlled by memory 24 and processor 22 to transmit the activated wakeup signal pattern to the user equipment.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for transmitting an indication to of one or more wakeup receiver capabilities to a network element. The apparatus may also include means for receiving an activated wakeup signal pattern from the network element selected from one or more wakeup signal patterns. In addition, the apparatus may include means for activating the one or more wakeup receiver capabilities at the wakeup receiver based on the activated wakeup signal pattern.

Certain example embodiments may also be directed to an apparatus that includes means for receiving an indication of one or more wakeup receiver capabilities from a user equipment. The apparatus may also include means for monitoring one or more conditions of the user equipment. In addition, the apparatus may include means for activating a wakeup signal pattern based on the monitoring of the one or more conditions of the user equipment. Further, the apparatus may include means for transmitting the activated wakeup signal pattern to the user equipment.

Other example embodiments may be directed to an apparatus that includes means for receiving a handover request message from a source network element. The apparatus may also include means for transmitting, in response to the handover request message, a handover request response message including network communication information to the source network element. The apparatus may further include means for transmitting, with point to multi-point service, multicast and broadcast services information to a user equipment in idle mode.

Certain example embodiments described herein provide several technical improvements, enhancements, and/or advantages. For instance, in some example embodiments, it may be possible to provide a NR WUS dynamic pattern selection and deployment that reduces the power consumption of the WRx used to wakeup the BBRx of an NR UE. According to other example embodiments, it may be possible to minimize costs of monitoring the WUS occasions, and improve power saving of an NR UE.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
G 5th Generation
5GCN 5G Core Network
5GS 5G System
AO Active Occasion
BBRx Baseband Receiver
BS Base Station
DCP DCI with CRC Scrambled by PS-RNTI
DL Downlink
eNB Enhanced Node B
E-UTRAN Evolved UTRAN
gNB 5G or Next Generation NodeB
HO Hybrid Occasion
LTE Long Term Evolution
NR New Radio
PO Passive Occasion
RE Resource Element
RSU Road Side Unit
UE User Equipment
UL Uplink
WRx Wakeup Receiver
WUS Wakeup Signal

1. A method comprising:
transmitting, by a user equipment, an indication of one or more wakeup receiver capabilities to a network element;
receiving an activated wakeup signal pattern from the network element selected from one or more wakeup signal patterns; and
activating the one or more wakeup receiver capabilities at the wakeup receiver based on the activated wakeup signal pattern.

2-8. (canceled)

9. A method, comprising:
receiving, by a network element, an indication of one or more wakeup receiver capabilities from a user equipment;
monitoring one or more conditions of the user equipment;
activating a wakeup signal pattern based on the monitoring of the one or more conditions of the user equipment; and
transmitting the activated wakeup signal pattern to the user equipment.

10-18. (canceled)

19. An apparatus, comprising:
at least one processor; and
at least one memory comprising computer program code,
the at least one memory and the computer program code are configured, with the at least one processor to cause the apparatus at least to
transmit an indication of one or more wakeup receiver capabilities to a network element;
receive an activated wakeup signal pattern from the network element selected from one or more wakeup signal patterns; and
activate the one or more wakeup receiver capabilities at the wakeup receiver based on the activated wakeup signal pattern.

20. The apparatus according to claim 19, wherein the at least one memory and the computer program code are further configured, with the at least one processor to cause the apparatus at least to:
receive one or more configuration options from the network element identifying the one or more wakeup signal patterns based on the one or more wakeup receiver capabilities.

21. The apparatus according to claim 19, wherein the one or more wakeup receiver capabilities comprises a passive branch capability or an active branch capability.

22. The apparatus according to claim 19, wherein the one or more wakeup receiver capabilities comprises:
an active branch capability; and
a passive branch capability.

23. The apparatus according to claim 19, wherein the activated wakeup signal pattern comprises:
a passive occasion wakeup signal;
an active occasion wakeup signal; or
a hybrid occasion wakeup signal.

24. The apparatus according to claim 23, wherein when the activated wakeup signal pattern comprises the passive occasion wakeup signal, activation of the one or more wakeup receiver capabilities comprises:
using a passive radio of a wakeup receiver,
wherein the passive radio harvests energy from the passive occasion wakeup signal and generates a binary signal.

25. The apparatus according to claim 23, wherein when the activated wakeup signal pattern comprises the active occasion wakeup signal, activation of the one or more wakeup receiver capabilities comprises:
using an active branch of a wakeup receiver.

26. The apparatus according to claim 23, wherein when the activated wakeup signal pattern comprises the hybrid occasion wakeup signal, activation of the one or more wakeup receiver capabilities comprises:
using a passive branch of a wakeup receiver while also buffering the hybrid occasion wakeup signal in stored in a non-transitory computer readable medium.

27. An apparatus, comprising:
at least one processor; and
at least one memory comprising computer program code,
the at least one memory and the computer program code are configured, with the at least one processor to cause the apparatus at least to
receive an indication of one or more wakeup receiver capabilities from a user equipment;
monitor one or more conditions of the user equipment;
activate a wakeup signal pattern from the wakeup signal pattern list based on the monitoring of the one or more conditions of the user equipment; and
transmit the activated wakeup signal pattern to the user equipment.

28. The apparatus according to claim 27, wherein the at least one memory and the computer program code are further configured, with the at least one processor to cause the apparatus at least to:
transmit one or more configuration options identifying one or more wakeup signal patterns to the user equipment in response to the indication.

29. The apparatus according to claim 27, wherein the activated wakeup signal is transmitted to the user equipment via a radio access control or a medium access control control element.

30. The apparatus according to claim 27,
wherein the one or more conditions comprises extrinsic and intrinsic conditions of the user equipment.

31. The apparatus according to claim 30,
wherein the extrinsic conditions comprise a user equipment coarse location or a network load in the user equipment proximity, and
wherein the intrinsic conditions comprise a user equipment battery level.

32. The apparatus according to claim 27, wherein the monitoring of extrinsic and intrinsic conditions further comprises the at least one memory and the computer program code being further configured, with the at least one processor to cause the apparatus at least to:
record a number of false positive or false negative wakeup decisions by the user equipment.

33. The apparatus according to claim 27, wherein the one or more wakeup receiver capabilities comprises a passive branch capability or an active branch capability.

34. The apparatus according to claim 27, wherein the one or more wakeup receiver capabilities comprises:
an active branch capability; and
a passive branch capability.

35. The apparatus according to claim 27, wherein the activated wakeup signal pattern comprises:
a passive occasion wakeup signal;
an active occasion wakeup signal; or
a hybrid occasion wakeup signal.

36. The apparatus according to claim 35, wherein the activated wakeup signal pattern is defined by:
a validity duration, or
a combination of the passive occasion wakeup signal, the active occasion wakeup signal, and the hybrid occasion wakeup signal.

37-56. (canceled)
